(19) United States
(12) Patent Application Publication
(10) Pub. No.: US 2014/0174986 A1
(43) Pub. Date: Jun. 26, 2014

(54) ELECTRICAL INDUCTION HEATING ASSEMBLY

(71) Applicant: Harry Dean Kassel, Sandton (ZA)

(72) Inventor: Harry Dean Kassel, Sandton (ZA)

(21) Appl. No.: 14/114,676

(22) PCT Filed: Apr. 26, 2012
(86) PCT No.: PCT/IB2012/052078

§ 371 Date: Feb. 13, 2014

(30) Foreign Application Priority Data
Apr. 30, 2011 (ZA) 2011/01810

(51) Int. Cl. H05B 6/10; C10G 9/24; H05B 1/02

(52) U.S. Cl. CPC H05B 6/108; H05B 1/0247; C10G 9/24
USPC 208/132; 219/628

(57) ABSTRACT

The invention discloses an electrical induction heating assembly which comprises an induction heating coil surrounding and being thermally insulated from a concentric closed cylindrical chamber having an inlet and an outlet. An electrically conductive element is located within or forms part of the chamber. The chamber includes means for uniform distribution of material that is to be heated in the chamber. A body of discreet agitating media is contained within the chamber. The body of discreet agitating media typically comprise steel balls.

### FIELD OF THE INVENTION

This invention relates to in line fluid and gas heating and more particularly to a thermal cracking system for the cracking of liquid hydrocarbons. It also has applications in the field of pyrolysis, the treatment of liquids and solids in multiple industries, and heating of liquids.

### BACKGROUND TO THE INVENTION

Electrical induction heating is used in many industries to convert electrical energy into heat and transfer this heat to a compound, article or medium. It is used for example to heat fluids in the food industry. Problems with such installations include typically the cost, size and efficiency of the equipment, which limits their applications.

A further specific application of an industry where heating is required is the thermal cracking industry. Thermal cracking is well known and different processes have been developed for this purpose. It is a process whereby complex organic molecules are broken down into simpler molecules such as light hydrocarbons, by the breaking of carbon-carbon bonds in the precursors.

Problems with conventional thermal cracking systems include typically the cost, size and efficiency of the heating equipment, which limits the usefulness of conventional thermal cracking technologies.

### OBJECT OF THE INVENTION

It is an object of the present invention to provide an assembly which is directly electrically powered to give a controlled heating capability.

### SUMMARY OF THE INVENTION

According to this invention there is provided an electrical induction heating assembly comprising an electrical induction heating coil at least partly surrounding and thermally insulated from a closed cylindrical chamber having an inlet and an outlet, an electrically conductive element located within or forming part of the chamber, means for uniform distribution of material to be heated in the chamber and a body of discreet agitating media contained within the chamber.

There is further provided for the heating assembly to include pressurisation means for the chamber, preferably in the form of pressure control valves in a processing circuit to which the chamber is operatively connected, more preferably in the form of pressure control valves proximate the inlet and outlet of the chamber.

There is further provided for the agitating media to be electrically conductive and to form an electrically conductive element within the chamber, and preferably also for the chamber to be electrically conductive, alternatively for the chamber to be electrically non-conductive.

There is still further provided for the inlet to be located proximate a first end of the chamber and for the outlet to be located proximate a second end of the chamber.

There is further provided for the thermal insulation between the induction heating coil and the chamber to comprise a thermal blanket, and further for the heating assembly to include thermal insulation around the heating coil, preferably in the form of a thermal blanket or a ceramic insulator located around the heating coil, and further preferably contained in a housing within which the assembly is contained.

There is further provided for the heat exchanger assembly to comprise a thermal cracking chamber assembly, and further for the uniform distribution means to comprise a rotatable axial shaft carrying at least one radial stirring paddle and for a drive motor to be mounted adjacent the chamber and connected to the shaft, and preferably for the shaft and paddle to be electrically conductive to provide further electrically conductive elements within the chamber.

There is still further provided for the shaft to include a conduit to which the inlet is connected around a liquid flow path, and for the conduit to have longitudinally spaced outlet openings into the chamber.

Further features of this invention provide for the agitating media to be steel, preferably steel balls, further preferably stainless steel balls, alternatively an abrasive particulate medium, preferably an electrically conductive medium, alternatively an electrically non-conductive medium.

There is still further provided for the outlet to include a screw conveyor.

According to a further feature of the invention there is provided for the uniform distribution means to comprise a cylindrical cage complimentary shaped to the inner dimensions of the chamber and secured to a rotatable axial shaft connected to a drive motor mounted adjacent the chamber, with the cage containing the body of discreet agitating media.

There is still further provided for the chamber to comprise a right circular cylindrical chamber.

This invention also provides a method of heating a liquid, preferably thermally cracking the liquid, comprising heating electrically conductive media for a liquid to be heated, preferably cracked, by induction in a chamber having an inlet and an outlet, receiving the liquid and having a body of stirred agitating media in the chamber, maintaining the chamber pressurised, the liquid being introduced into the chamber through the inlet and the heated product collected through the outlet from the chamber.

There is further provided for the method to include collecting cracked product through an outlet from the chamber and solid material formed during the cracking transported to and removed from the outlet from the chamber by agitation of the media.

### BRIEF DESCRIPTION OF THE DRAWINGS

The invention is described in detail below where reference is made to the accompanying diagrammatic drawings in which:

FIG. 1 shows a diagrammatic cross-sectional view of a thermal cracking chamber according to the invention; and

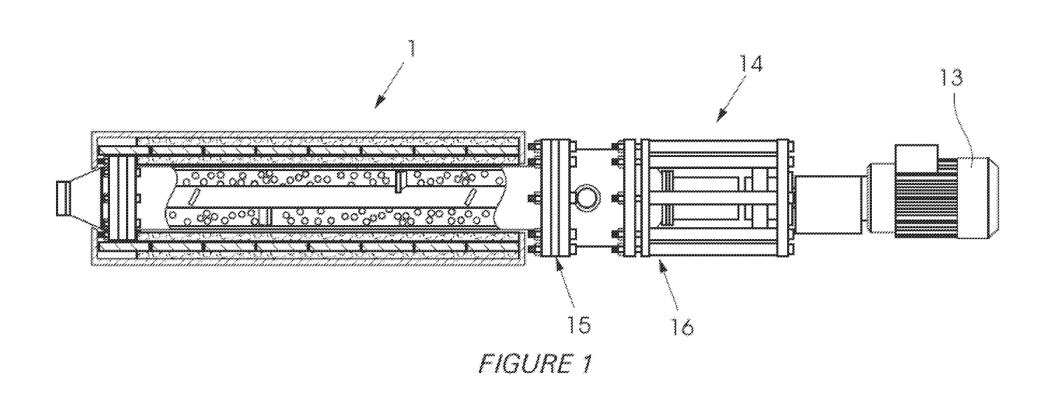

FIG. 2 shows a close-up view of part of FIG. 1.

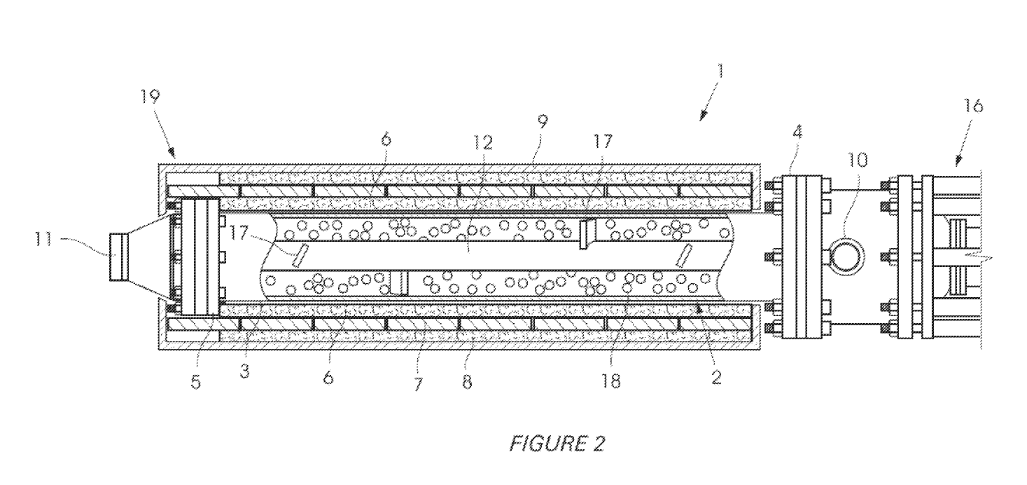

### DETAILED DESCRIPTION OF THE INVENTION

A preferred embodiment of the invention comprises a thermal cracking chamber assembly, which is used for cracking oil, such as used industrial oil and the like, to produce useable and valuable fuel and by-products.

As illustrated a thermal cracking assembly (1) include a cracking chamber (2) which may be built up from a stainless steel cylinder (3) having end closure members (4, 5). Other materials including suitable glass, ceramic, and graphite may be used for the cylinder (3). The chamber (2) forms part of an assembly which includes a thermal insulating blanket (6) wrapped around the cylinder (3) and radially spaced apart therefrom is an induction heating coil (7). The blanket (6) minimizes heat loss from the chamber (2). A further thermal insulating blanket (8) is wrapped around the heating coil (7), and enclosed in a housing (9), which contains the chamber (2), heating coil (7) and thermal insulating blankets (6, 8). The induction heating coil (7) is located concentric with the chamber (2) to optimise heating.

The induction hearting coil (7) is electrically connected to a 50 KW power generator located distal from the assembly.

An inlet (10) is provided in one end of the chamber (2) and an outlet (11) at the opposite end. A shaft (12) extends through one end of the chamber (2), in this instance the inlet (10) end. The shaft (12) is secured to an electric drive motor (13) by means of a coupling (14). The shaft (12) extends through a set of graphite or ceramic based seals (15) and bearings (16) into the chamber (2). The shaft (12) includes a plurality of radially extending paddles (17) spaced apart along its length within the chamber (2). The paddles (17) extend radially from the shaft to proximate the inner surface of the chamber (2).

The drive (13) is located distal from the chamber (2) by means of the coupling (14). This locates the drive (13) away from heat emanating from the chamber (2) during operation, which affords adequate protection against induction induced eddy currents and the heat generated during the cracking process. The rigid coupling also ensures that the shaft runs true within the chamber (2) during operation.

The chamber (2) is filled around the shaft (12) with stainless steel balls (18). The outlet (11) end of the chamber includes a strainer (19) in the form of a perforated plate to retain the balls (18) inside the chamber (2). The apertures in the strainer (19) are smaller than the diameter of the ball bearings (18). Since the balls (18) experience wear during operation the chamber will be serviced at regular intervals during at which time worn balls (18) will be removed before they wear enough to pass through the strainer (19). Solid materials generated in the cracking process can pass through the strainer (19) to the outlet for extraction.

The balls (18), shaft (12), paddles (17) and chamber (2) are all electrically conductive which means they heat up as a result of the induction. This heat is transferred to the oil passing through the chamber (2).

The assembly (1) including its drive (13) is operatively located in line in a thermal cracking process. Used oil is pumped into the chamber (2) where it is subjected to pressurised heating. The oil may be heated to about 280° C. and 800° C. and subjected to pressures as high as 28 bar. Typically the chamber is maintained pressurised, meaning it will be kept above atmospheric pressure. The chamber is pressurised by pressure control valves in the inlet and outlet passages to the chamber, which between them maintain the chamber pressurised.

The pressurised heating results in thermal cracking of the oil in known manner. The cracking produces liquid and solid products. The solids are removed from the chamber by means of agitation by the ball bearings (18), which moves the solids through the outlet (11). The outlet is provided with a screw conveyor to facilitate movement of the solids away from the chamber (2).

The solid and liquid products of the cracking are further treated using known techniques for thermal cracking, including evaporation, condensation and separation.

The chamber (2) may also be provided with an inert gas inlet to optimise the cracking process.

Dimensions of the unit can be made to suit particular applications and a practical embodiment would have a cylinder length of about 100 cm and diameter of about 14-20 cm. The assembly may be scaled up by increasing its diameter and/or its length. The preferred method of scaling up will be to increase the diameter since increasing the length puts greater strain on the shaft (12) and drive (13), and it becomes more difficult to keep the shaft from bending during operation, which is unwanted since it could cause the paddles to catch on the inner surface of the chamber (2).

The above illustrates that the assembly is compact and should not exceed the mass required to efficiently heat used oil introduced into the system to the required temperature.

A specific installation of a cracking unit as described above will be modified for the particular application and such modifications will be within the ability of those skilled in the art. It will also be appreciated by those skilled in the art that the invention described can be adapted for use in heat exchangers, boilers and pyrolysis processes.

It will be appreciated that the embodiment described above is given by way of example only and is not intended to limit the scope of the invention and its protection. It is for example possible to include a cage within and concentric with the chamber, with the shaft being secured to the cage. The cage will contain the agitating media, typically the balls bearing, and will be rotatable by means of the shaft. This will eliminate the need for the strainer and possibly also the paddles.

Further alternatives include for the chamber to be made from ceramic, for the balls forming the agitating media to comprise steel balls. The outlet may be operated without a screw conveyor fitted to it.

1-19. (canceled)

20. An electrical induction heating and thermal cracking assembly, comprising:
an induction heating coil surrounding and being thermally insulated from a concentric closed cylindrical chamber having an inlet and an outlet;
an electrically conductive element located within or forming part of the concentric closed cylindrical chamber;
means for uniform distribution of material to be heated and thermally cracked in the concentric closed cylindrical chamber; and
a body of discrete agitating media contained within the concentric closed cylindrical chamber.

21. The electrical induction heating and thermal cracking assembly as claimed in claim 20, further comprising pressurisation means for the concentric closed cylindrical chamber.

22. The electrical induction heating and thermal cracking assembly as claimed in claim 21 in which the pressurisation means includes pressure control valves in a processing circuit to which the concentric closed cylindrical chamber is operatively connected.

23. The electrical induction heating and thermal cracking assembly as claimed in claim 21 in which the pressurisation means for the concentric closed cylindrical chamber includes pressure control valves proximate to the inlet and outlet of the concentric closed cylindrical chamber.

24. An electrical induction heating assembly, comprising:
an induction heating coil surrounding and being thermally insulated from a concentric closed cylindrical chamber having an inlet and an outlet;
an electrically conductive element located within or forming part of the concentric closed cylindrical chamber;
means for uniform distribution of material to be heated in the concentric closed cylindrical chamber; and
a body of discrete agitating media contained within the concentric closed cylindrical chamber, which includes pressurisation means for the concentric closed cylindrical chamber.

25. The electrical induction heating assembly as claimed in claim 24 in which the pressurisation means includes pressure control valves in a processing circuit to which the chamber is operatively connected.

26. The electrical induction heating assembly as claimed in claim 24 in which the pressurisation means includes pressure control valves proximate to the inlet and outlet of the chamber.

27. The electrical induction heating assembly as claimed in claim 25 in which the agitating media is electrically conductive and the electrically conductive element is located within the concentric closed cylindrical chamber.

28. The electrical induction heating assembly as claimed in claim 24 in which the concentric closed cylindrical chamber is electrically conductive and the electrically conductive element forms part of the concentric closed cylindrical chamber.

29. The electrical induction heating assembly as claimed in claim 24 in which the inlet is located proximate to a first end of the concentric closed cylindrical chamber and the outlet is located proximate to a second end of the concentric closed cylindrical chamber.

30. The electrical induction heating assembly as claimed in claim 24 in which the thermal insulation between the induction heating coil and the concentric closed cylindrical chamber includes a thermal insulating blanket.

31. The electrical induction heating assembly as claimed in claim 24 in which the means for uniform distribution includes a rotatable axial shaft carrying at least one radial stirring paddle and a drive motor is mounted adjacent to the concentric closed cylindrical chamber and connected to the rotatable axial shaft.

32. The electrical induction heating assembly as claimed in claim 31 in which the rotatable axial shaft and the at least one radial stifling paddle are electrically conductive and include a further electrically conductive element within the concentric closed cylindrical chamber.

33. The electrical induction heating assembly as claimed in claim 32 in which the rotatable axial shaft includes a conduit to which the inlet is connected around a liquid flow path, and the conduit has longitudinally spaced outlet openings into the concentric closed cylindrical chamber.

34. The electrical induction heating assembly as claimed in claim 24 in which the body of discrete agitating media includes steel balls.

35. The electrical induction heating assembly as claimed in claim 24 in which the body of discrete agitating media includes stainless steel balls.

36. The electrical induction heating assembly as claimed in claim 24 in which the outlet includes a screw conveyor.

37. The electrical induction heating assembly as claimed in claim 24 in which the means for uniform distribution includes a cylindrical cage complimentary shaped to the inner dimensions of the concentric closed cylindrical chamber and secured to a rotatable axial shaft which is connected to a drive motor mounted adjacent to the concentric closed cylindrical chamber, the cylindrical cage containing the body of discrete agitating media.

38. The electrical induction heating assembly as claimed in claim 24 in which the concentric closed cylindrical chamber includes a right circular cylindrical chamber.

39. A method of heating and thermally cracking a fluid, comprising:
heating a body of electrically conductive stirred agitating media by electrical induction in a chamber having an inlet and an outlet;
receiving the fluid through the inlet in the chamber;
stirring the heated body of agitating media in the chamber to thermally crack the fluid; and
collecting the heated and thermally cracked product through the outlet.

40. The method as claimed in claim 39, further comprising:
transporting, by agitation of the media, solid material formed during the cracking of the fluid to the outlet; and
removing the solid material from the outlet.

41. The method as claimed in claim 39, further comprising pressurisation of the chamber.
